(19) United States
(12) Patent Application Publication
(10) Pub. No.: US 2011/0253913 A1
(43) Pub. Date: Oct. 20, 2011

(54) CHAMBER APPARATUS

(76) Inventors: Shinji NAGAI, Hiratsuka-shi (JP); Osamu WAKABAYASHI, Hiratsuka-shi (JP)

(21) Appl. No.: 13/070,735

(22) Filed: Mar. 24, 2011

(30) Foreign Application Priority Data
Mar. 29, 2010 (JP) 2010-076254
Dec. 24, 2010 (JP) 2010-288901
Jan. 24, 2011 (JP) 2011-012096

(51) Int. Cl. G01J 3/10

(52) U.S. Cl. 250/504 R

(57) ABSTRACT

A chamber apparatus used with a laser apparatus and a focusing optical system for focusing a laser beam outputted from the laser apparatus may include: a chamber provided with an inlet through which the laser beam is introduced into the chamber; a target supply unit provided to the chamber for supplying a target material to a predetermined region inside the chamber; and a collection unit provided in the chamber for collecting a charged particle generated when the target material is irradiated with the laser beam in the chamber.

### CROSS-REFERENCE TO RELATED APPLICATIONS

The present application claims priority from Japanese Patent Application No. 2010-076254 filed on Mar. 29, 2010, Japanese Patent Application No. 2010-288901 filed on Dec. 24, 2010, and Japanese Patent Application No. 2011-012096 filed on Jan. 24, 2011, the disclosure of each of which is incorporated herein by reference in its entirety.

### BACKGROUND

1. Technical Field

This disclosure relates to a chamber apparatus.

2. Related Art

In an LLP-type extreme ultraviolet (EUV) light generation apparatus in which plasma generated by irradiating a target material with a laser beam is used, the target material is irradiated with the laser beam in a chamber, whereby the target material is turned into plasma, and EUV light at a desired wavelength of 13.5 nm, for example, emitted from the target material that has been turned into plasma is selectively collected. A collector mirror having a concave reflective surface which collects light emitted at a given point is used to collect the EUV light. The EUV light collected by the collector mirror is propagated to an exposure apparatus and used for photolithography, laser processing, and so forth.

### SUMMARY

A chamber apparatus according to one aspect of this disclosure may be used with a laser apparatus and a focusing optical system for focusing a laser beam outputted from the laser apparatus, and the chamber apparatus may include: a chamber provided with an inlet through which the laser beam is introduced into the chamber; a target supply unit provided to the chamber for supplying a target material to a predetermined region inside the chamber; and a collection unit provided in the chamber for collecting a charged particle generated when the target material is irradiated with the laser beam in the chamber.

These and other objects, features, aspects, and advantages of this disclosure will become apparent to those skilled in the art from the following detailed description, which, taken in conjunction with the annexed drawings, discloses preferred embodiments of this disclosure.

### BRIEF DESCRIPTION OF DRAWINGS

FIG. 1 is a sectional view schematically illustrating the configuration of an EUV light generation apparatus according to a first embodiment of this disclosure.

FIG. 2 schematically illustrates a section of the EUV light generation apparatus 1 shown in FIG. 1, the section being taken along a different plane containing an axis of the EUV light.

FIG. 3A is a sectional view schematically illustrating the configuration of a debris collection unit according to the first embodiment of this disclosure.

FIG. 3B schematically illustrates the configuration of the debris collection unit shown in FIG. 3A, as viewed in the direction in which an ion flow is incident on the debris collection unit.

FIG. 4 is a sectional view schematically illustrating the configuration of a debris collection unit according to a second embodiment of this disclosure.

FIG. 5 is a sectional view schematically illustrating the configuration of a debris collection unit according to a modification of the second embodiment of this disclosure.

FIG. 6 is a sectional view schematically illustrating the configuration of a debris collection unit according to a third embodiment of this disclosure.

FIG. 7 is a sectional view schematically illustrating the configuration of a debris collection unit according to a modification of the third embodiment of this disclosure.

FIG. 8 is a sectional view schematically illustrating the configuration of a debris collection unit according to a fourth embodiment of this disclosure.

FIG. 9 is a sectional view schematically illustrating the configuration of a debris collection unit according to a first modification of the fourth embodiment of this disclosure.

FIG. 10 is a sectional view schematically illustrating the configuration of a debris collection unit according to a second modification of the fourth embodiment of this disclosure.

FIG. 11 is a sectional view schematically illustrating the configuration of a debris collection unit according to a fifth embodiment of this disclosure.

FIG. 12 is a sectional view schematically illustrating the configuration of a debris collection unit according to a first modification of the fifth embodiment of this disclosure.

FIG. 13 is a sectional view schematically illustrating the configuration of a debris collection unit according to a second modification of the fifth embodiment of this disclosure.

FIG. 14A is a sectional view schematically illustrating the configuration of a debris collection unit according to a sixth embodiment of this disclosure.

FIG. 14B schematically illustrates the configuration of the debris collection unit shown in FIG. 14A, as viewed in the direction in which an ion flow is incident on the debris collection unit.

FIG. 15 is a sectional view schematically illustrating the configuration of a debris collection unit according to a first modification of the sixth embodiment of this disclosure.

FIG. 16 is a sectional view schematically illustrating the configuration of a debris collection unit according to a second modification of the sixth embodiment of this disclosure.

FIG. 17 is a sectional view schematically illustrating the configuration of a debris collection unit according to a third modification of the sixth embodiment of this disclosure.

FIG. 18A is a sectional view schematically illustrating the configuration of a debris collection unit according to a seventh embodiment of this disclosure.

FIG. 18 B schematically illustrates the configuration of the debris collection unit shown in FIG. 18A, as viewed in the direction in which an ion flow FL is incident on the debris collection unit.

FIG. 19A is a sectional view schematically illustrating the configuration of a debris collection unit according to an eighth embodiment of this disclosure.

FIG. 19B schematically illustrates the configuration of the debris collection unit shown in FIG. 19A, as viewed in the direction in which an ion flow FL is incident on the debris collection unit.

### DETAILED DESCRIPTION OF PREFERRED EMBODIMENTS

Hereinafter, embodiments for implementing this disclosure will be described in detail with reference to the accompanying drawings. In the subsequent description, each drawing merely illustrates shape, size, positional relationship, and so on, schematically to the extent that enables the content of this disclosure to be understood; thus, this disclosure is not limited to the shape, the size, the positional relationship, and so on, illustrated in each drawing. In order to show the configuration clearly, part of hatching along a section is omitted in the drawings. Further, numerical values indicated hereafter are merely preferred examples of this disclosure; thus, this disclosure is not limited to the indicated numerical values.

### First Embodiment

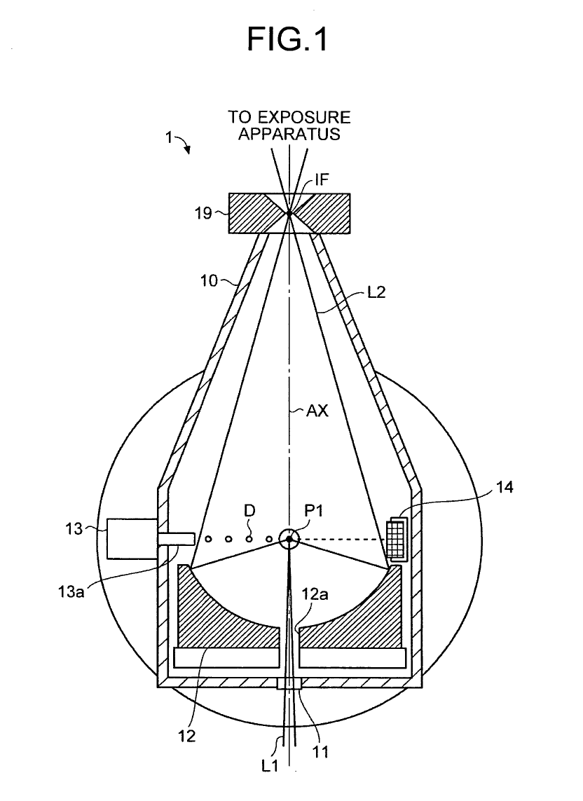

An EUV light generation apparatus according to a first embodiment of this disclosure will be described in detail with reference to the drawings. FIG. 1 is a sectional view schematically illustrating the configuration of the EUV light generation apparatus according to the first embodiment. FIG. 1 is a section of the EUV light generation apparatus taken along a plane containing an axis AX of EUV light L2 reflected by an EUV collector mirror 12.

As illustrated in FIG. 1, an EUV light generation apparatus 1 may include a chamber 10 that defines thereinside a space where EUV light is generated. The chamber 10 may be provided with a droplet generator 13 in which tin (Sn), which is a target material serving as a source for generation of the EUV light L2, is stored in a molten state. The droplet generator 13 may be provided with a nozzle 13a at the leading end thereof, and the droplet generator 13 may preferably be disposed such that the tip of the nozzle 13a is oriented toward a predetermined position in a plasma generation region P1 inside the chamber 10. A Sn droplet D may be outputted through the tip of the nozzle 13a toward the plasma generation region P1. The droplet generator 13 may output molten Sn in the form of a liquid droplet D through the tip of the nozzle 13a by utilizing, for example, the internal pressure thereof. However, without being limited thereto, the droplet generator 13 may be modified in various ways: for example, as a so-called electrostatic attraction type droplet generator, in which an electrode for pulling out molten Sn with electrostatic force is provided so as to face the tip of the nozzle 13a; as a so-called electrostatic attraction acceleration type droplet generator, in which, in addition to the above electrode, another electrode for accelerating the pulled-out droplets D with electrostatic force is provided; and the like.

The droplet D supplied into the chamber 10 may be irradiated with a laser beam L1 outputted from an external driver laser via a window 11 provided to the chamber 10 at timing at which the droplet D arrives in the plasma generation region P1. With this, the droplet D may be turned into plasma in the plasma generation region P1. Light including light at a predetermined wavelength may be emitted from the droplet D that has been turned into plasma, when the plasma is de-excited. Further, the EUV collector mirror 12 that selectively reflects the EUV light L2 at a predetermined wavelength among the light emitted in the plasma generation region P1 may be disposed inside the chamber 10. The EUV light L2 reflected by the EUV collector mirror 12 may be focused at a predetermined point (intermediate focus IF) in an exposure-apparatus-connecting unit 19, which is a connection between the EUV light generation apparatus 1 and an exposure apparatus (not shown), and may subsequently be propagated to the exposure apparatus. The droplet D supplied into the plasma generation region P1 may be irradiated with the laser beam L1 via a through-hole 12a provided in the center of the EUV collector mirror 12.

The chamber 10 may be provided with a target collection unit 14 for collecting droplets D that have passed through the plasma generation region P1, part of droplets D which has not been turned into plasma even when being irradiated with the laser beam L1, an so forth. The target collection unit 14 may preferably be disposed, for example, on the extension of a line connecting the tip of the nozzle 13a of the droplet generator 13 and the plasma generation region P1, or, if the trajectory of the droplet D is curved, on the extension of the trajectory.

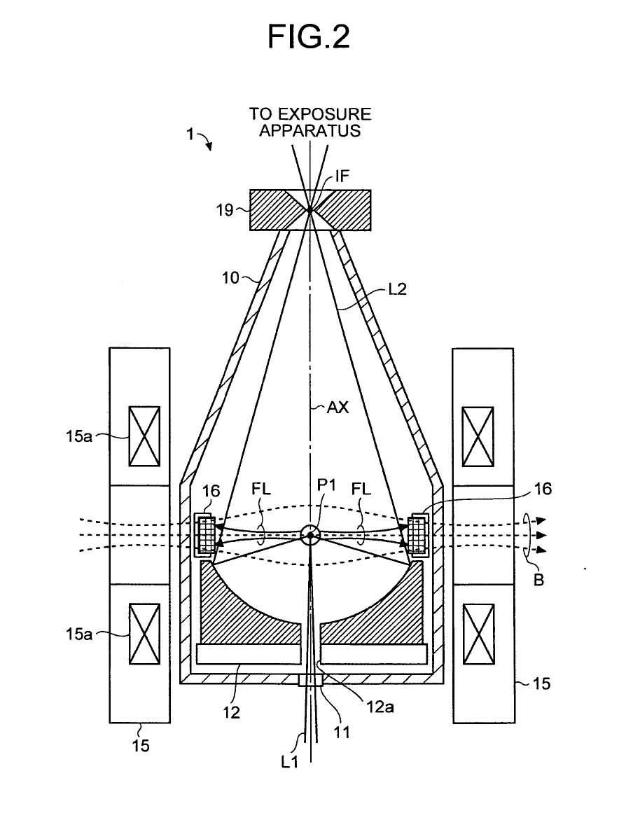

FIG. 2 schematically illustrates a section of the EUV light generation apparatus 1 shown in FIG. 1, the section being taken along a different plane containing the axis of the EUV light.

As illustrated in FIG. 2, the EUV light generation apparatus 1 may include magnetic field generation units 15 provided outside the chamber 10 and debris collection units 16 provided inside the chamber 10. The magnetic field generation units 15 may be constituted by a pair of electromagnetic coils 15a disposed with the chamber 10 provided therebetween. The magnetic field generation units 15 may preferably be disposed such that the line connecting the centers of the bores of the two electromagnetic coils 15a passes through the plasma generation region P1 inside the chamber 10. Hence, the magnetic field generation units 15 may generate a magnetic field B of which the center of magnetic flux passes through the plasma generation region P1. The magnetic field B may trap charged debris among debris of the target material (Sn) generated in the plasma generation region P1 when EUV light is generated. The debris trapped in the magnetic field B may form an ion flow FL with the Lorentz force. The debris collection units 16 may be provided at positions toward which the ion flow FL travels. As the ion flow FL travels along the magnetic field B, debris generated in the plasma generation region P1 may be collected into the debris collection units 16.

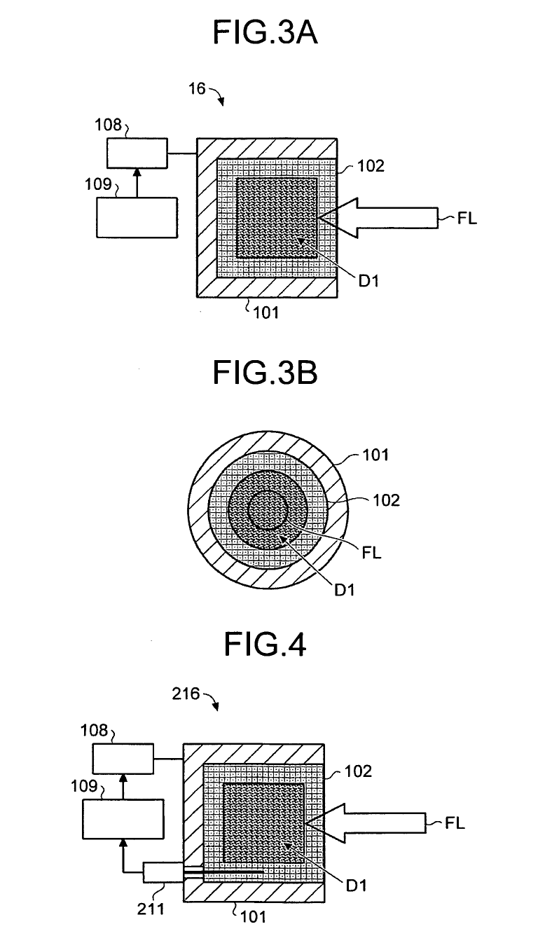

The debris collection units 16 according to the first embodiment will be described in detail with reference to the drawings. FIG. 3A is a sectional view schematically illustrating the configuration of the debris collection unit according to the first embodiment. FIG. 3A illustrates the configuration of the debris collection unit with a section taken along a plane containing the center of the magnetic flux of the magnetic field B. FIG. 3B schematically illustrates the configuration of the debris collection unit shown in FIG. 3A, as viewed in the direction in which the ion flow is incident on the debris collection unit.

As illustrated in FIGS. 3A and 3B, the debris collection unit 16 may include, for example, a cylindrical porous member (porous material) 102 serving as a member for trapping Sn debris incident thereon in the form of the ion flow FL. The porous member 102 may be provided, on the surface thereof, with numerous openings communicating with air voids formed thereinside. Debris D1 incident on the porous member 102 as the ion flow FL may permeate through the openings in the surface into the air voids thereinside with the capillarity. With this, the debris D1 may be trapped and stored inside the porous member 102.

The debris collection unit 16 may be provided with a heater 101 for heating the porous member 102. Electric current may be supplied to the heater 101 from a power supply 108 provided outside the chamber 10, for example, and the heater 101 may heat the porous member 102 to a temperature range within which the debris D1 (Sn) is in a molten state. With this, the porous member 102 may be maintained in a state in which the debris incident thereon can be trapped. Note that the porous member 102 may preferably be maintained at a temperature below the temperature at which the material constituting the porous member 102 reacts with the target material (Sn). For example, when the target material is Sn and the material constituting the porous member 102 is Cu, Sn reacts with Cu at or above 280° C.; thus, the porous member 102 may preferably be maintained below 280° C. The temperature of the porous member 102 may be controlled with a temperature controller 109, connected to the power supply 108, controlling the electric current supplied to the heater 101 from the power supply 108.

The porous member 102 is preferably configured of a material having high wettability to molten Sn. Examples of such a material may include aluminum (Al), copper (Cu), silicon (Si), nickel (Ni), titanium (Ti), and the like, as listed in Table 1 below. By employing such a material having high wettability to the debris, the debris incident on the porous member 102 can be allowed to permeate into the porous member 102 efficiently. Consequently, the amount of Sn (debris D1) present on the surface of the porous member 102, onto which the debris is incident, can be reduced; therefore, the occurrence of re-sputtering by the trapped Sn (debris D1) in the ion flow FL may be suppressed.

TABLE 1

| | | | Sn Sputtering | | |
|---|---|---|---|---|---|
| | | | Property | | |
| | Wettability | | Sputtering | Porous Formation | |
| | Contact | | Rate 1 keV, | | Pore |
| Material | Angle | cosθ | AOI = 0° C. | Porosity | Size |
| Al | 43 | 0.73 | 0.87 | 30-80% | 1-100 μm |
| Cu | 64 | 0.44 | 2.04 | 30-80% | 1-100 μm |
| Si | 79 | 0.19 | 0.44 | | |
| Ni | 80 | 0.17 | 1.49 | 30-80% | 1-100 μm |
| Ti | 89 | 0.02 | 0.41 | 30-80% | 25 μm |
| SiC | 138 | −0.74 | 0.60 | | |
| C | 180 | −1.0 | 0.16 | 12-17% | 2-3.5 μm |

With such a configuration, according to the first embodiment, debris generated when the EUV light L2 is generated can be collected in the debris collection unit 16; thus, the deterioration in the characteristics and the performance of elements provided in the chamber 10 caused by the debris adhering thereonto can be suppressed.

While the debris collection unit 16 has been described above, it is possible to apply the same configuration to the target collection unit 14 as well, for example. Accordingly, the target material that has passed through the plasma generation region P1 can be collected in the target collection unit 14; thus, the deterioration in the characteristics and the performance of elements provided in the chamber caused by the target material adhering thereonto can be suppressed.

### Second Embodiment

Next, an EUV light generation apparatus and a debris collection unit according to a second embodiment of this disclosure will be described in detail with reference to the drawing. The EUV light generation apparatus according to the second embodiment is similar in configuration to the EUV light generation apparatus 1 shown in FIGS. 1 and 2, but the debris collection unit 16 is replaced by a debris collection unit 216. Other configurations are similar to those shown in FIGS. 1 and 2, and duplicate descriptions thereof are omitted here.

FIG. 4 is a sectional view schematically illustrating the configuration of the debris collection unit according to the second embodiment. FIG. 4 illustrates the configuration of the debris collection unit with a section taken along a plane containing the center of the magnetic flux of the magnetic field B. As illustrated in FIG. 4, the debris collection unit 216 may be similar in configuration to the debris collection unit 16 shown in FIG. 3, and may further include a temperature sensor 211 for detecting the temperature of the porous member 102. The temperature detected by the temperature sensor 211 may be inputted to the temperature controller 109. The temperature controller 109 may perform feedback control of the electric current supplied to the heater 101 from the power supply 108 based on the temperature inputted thereto. With this, the temperature of the porous member 102 may reliably be controlled to fall within a predetermined temperature range (for example, at or above 232° C. and below 280° C.)

Other configurations and operations are similar to those of the first embodiment described above, and duplicate descriptions thereof are omitted here.

### Modification

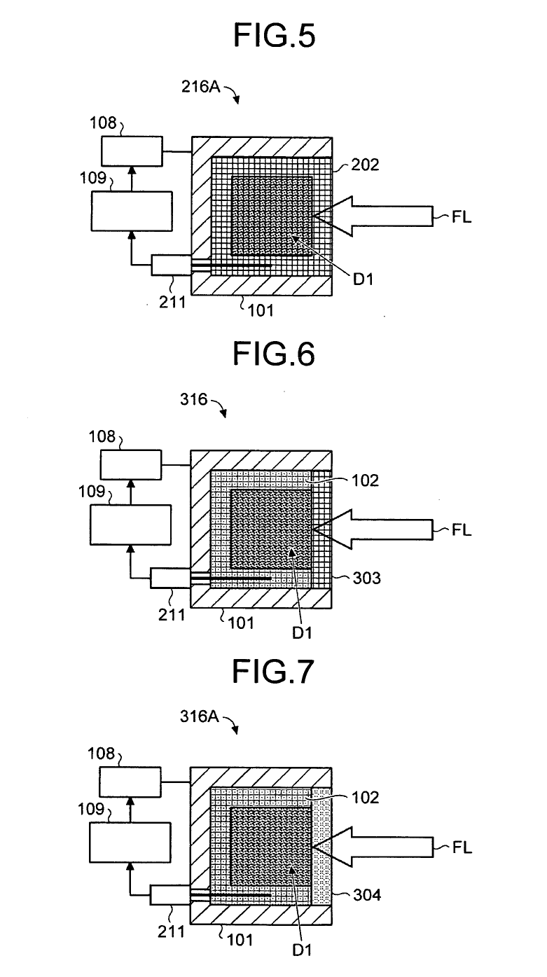

FIG. 5 is a sectional view schematically illustrating the configuration of a debris collection unit according to a modification of the second embodiment. The porous member 102 exemplified in the second embodiment described above may be replaced by a mesh member (porous material) 202 having a three-dimensional mesh structure in which, for example, wires, ribbons, or the like intersect three-dimensionally, as in a debris collection unit 216A shown in FIG. 5. The mesh member 202 may be provided, in the surface thereof, with numerous openings communicating with air voids formed thereinside, as in the porous member 102. The debris D1 incident on the mesh member 202 as the ion flow FL may permeate through the openings in the surface into the air voids thereinside. With this, the debris D1 may be trapped and stored in the mesh member 202.

The porous member 102 may be configured of any member aside from the mesh member 202 having a three-dimensional mesh structure, as long as the member has a structure which allows a liquid target material to permeate thereinto with the capillarity or the like, such as a member obtained by sintering particles of several microns in size, a member obtained by solidifying fibrous members, and so forth. Moreover, replacing the porous member with the mesh member or the like is also applicable in other embodiments and the modifications thereof.

### Third Embodiment

Next, an EUV light generation apparatus and a debris collection unit according to a third embodiment of this disclosure will be described in detail with reference to the drawing. The EUV light generation apparatus according to the third embodiment may be similar in configuration to the EUV light generation apparatus 1 shown in FIGS. 1 and 2, but the debris collection unit 16 is replaced by a debris collection unit 316. Other configurations are similar to those shown in FIGS. 1 and 2, and duplicate descriptions thereof are omitted here.

FIG. 6 is a sectional view schematically illustrating the configuration of the debris collection unit according to the third embodiment. FIG. 6 illustrates the configuration of the debris collection unit with a section taken along a plane containing the center of the magnetic flux of the magnetic field B. As illustrated in FIG. 6, the debris collection unit 316 may be similar in configuration to the debris collection unit 216 shown in FIG. 4, but a mesh member 303 may be provided on the surface of the porous member 102 onto which the ion flow FL may be incident. The mesh member 303 may, for example, be configured of a member having a similar configuration to the mesh member 202 shown in FIG. 5. The debris D1 incident on the mesh member 303 as the ion flow FL may permeate into the mesh member 303 through the openings in the surface thereof, and may subsequently permeate through the porous member 102 provided so as to be in contact with a surface opposite the surface onto which the debris D1 is incident. With this, the debris D1 may be trapped and stored in the porous member 102. Note that the mesh member 303 may preferably have lower wettability to the debris D1 than the porous member 102.

The mesh member 303 may preferably be configured of a material that is less likely to be sputtered when the ion flow FL is incident thereonto, such as those listed in Table 1 above. Examples of such a material may include carbon (C), tungsten (W), silicon (Si), tungsten carbide (WC), titanium (Ti), silicon carbide (SiC), aluminum (Al), and so forth.

Other configurations and operations are similar to those of the above-described embodiments and the modifications thereof, and duplicate descriptions thereof are omitted here.

### Modification

FIG. 7 is a sectional view schematically illustrating the configuration of a debris collection unit according to a modification of the third embodiment. The mesh member 303 exemplified in the third embodiment described above may be replaced by a porous member 304 as in a debris collection unit 316A shown in FIG. 7. The porous member 304 may be provided, in the surface thereof, with numerous openings communicating with air voids formed thereinside, as in the porous member 102. The debris D1 incident on the porous member 304 as the ion flow FL may permeate into the porous member 304 through the openings in the surface, and may subsequently permeate into the porous member 102 provided so as to be in contact with the surface opposite the surface onto which the debris D1 is incident. With this, the debris D1 may be trapped inside the porous member 102. Further, the porous member 304 may preferably be configured of a material that is less likely to be sputtered when the ion flow FL is incident thereonto. The porous member 304 may preferably have lower wettability to the debris D1 than the porous member 102.

The mesh member 303 and the porous member 304 may be configured of any member, as long as the member has a structure which allows a liquid target material to permeate thereinto with the capillarity or the like, such as a member obtained by sintering particles of several microns in size, a member obtained by solidifying fibrous members, and so forth. The mesh member 303 and the porous member 304 may be several tens of microns in thickness in the direction in which the ion flow FL is incident thereon. The configuration in which the mesh member 303 or the porous member 304 is provided on the surface of the debris collection unit on which the ion flow FL is incident may also be applicable to other embodiments and the modifications thereof.

### Fourth Embodiment

An EUV light generation apparatus and a debris collection unit according to a fourth embodiment of this disclosure will be described in detail with reference to the drawing. The EUV light generation apparatus according to the fourth embodiment may be similar in configuration to the EUV light generation apparatus 1 shown in FIGS. 1 and 2, but the debris collection unit 16 is replaced by a debris collection unit 416. Other configurations are similar to those shown in FIGS. 1 and 2, and duplicate descriptions thereof are omitted here.

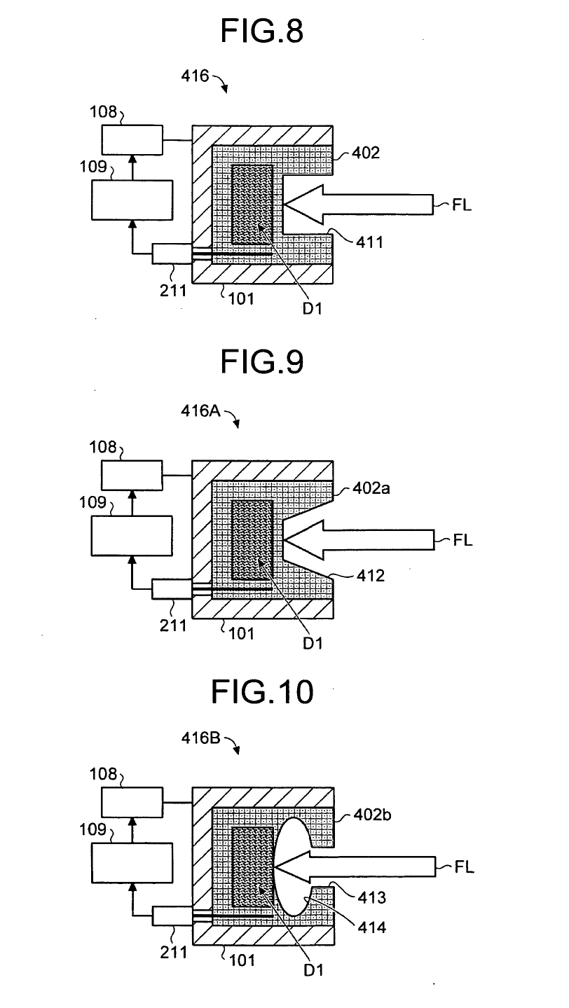

FIG. 8 is a sectional view schematically illustrating the configuration of the debris collection unit according to the fourth embodiment. FIG. 8 illustrates the configuration of the debris collection unit with a section taken along a plane containing the center of the magnetic flux of the magnetic field B. As illustrated in FIG. 8, the debris collection unit 416 may be similar in configuration to the debris collection unit 216 shown in FIG. 4, but the porous member 102 is replaced by a porous member 402. The porous member 402 may, for example, be configured of a similar member to the porous member 102 shown in FIG. 4. The porous member 402 may, for example, be provided with a cup-shaped pocket 411 at the surface on which the ion flow FL is incident, the pocket 411 being opened wider than the cross section of the ion flow FL. The cup-shaped pocket 411 for receiving the ion flow FL being provided on the surface on which the ion flow FL is incident, sputtered materials generated as the ion flow FL is incident thereon may be trapped on the side surface of the pocket 411. With this, the sputtered materials can be prevented from being scattered in the chamber 10.

Other configurations and operations are similar to those of the above described embodiments and the modifications thereof, and duplicate descriptions thereof are omitted here.

### First Modification

FIG. 9 is a sectional view schematically illustrating the configuration of a debris collection unit according to a first modification of the fourth embodiment. The porous member 402 exemplified in the fourth embodiment described above may be replaced by a porous member 402a, as in a debris collection unit 416A shown in FIG. 9. In the porous member 402a, the cup-shaped pocket 411 in the porous member 402 may be replaced by a frustoconical pocket 412. The side surface of the pocket 412 being inclined with respect to the direction in which the ion flow FL is incident thereon, the collision density of Sn per unit area, which the side surface receives from each individual debris, can be reduced. Consequently, the occurrence of re-sputtering caused as the ion flow FL is incident thereon can be suppressed.

### Second Modification

FIG. 10 is a sectional view schematically illustrating the configuration of a debris collection unit according to a second modification of the fourth embodiment. The porous member 402 or 402a described above may be replaced by a porous member 402b, as in a debris collection unit 416B shown in FIG. 10. In the porous member 402b, the cup-shaped pocket 411 in the porous member 402 may, for example, be replaced by an opening 413, provided in the surface on which the ion flow FL is incident and, for example, being wider than the cross section of the ion flow FL, and a hollow space 414, provided in an inner portion of the porous member 402b with respect to the surface on which the ion flow FL is incident, the hollow space 414 being in communication with the opening 413 and wider than the opening 413. A space (the hollow space 414) wider than the opening 413 being provided in an inner portion of the porous member 402b, sputtered materials generated as the ion flow FL is incident thereon can more reliably be prevented from being scattered in the chamber 10.

### Fifth Embodiment

An EUV light generation apparatus and a debris collection unit according to a fifth embodiment of this disclosure will be described in detail with reference to the drawing. The EUV light generation apparatus according to the fifth embodiment may be similar in configuration to the EUV light generation apparatus 1 shown in FIGS. 1 and 2, but the debris collection unit 16 is replaced by a debris collection unit 516. Other configurations are similar to those shown in FIGS. 1 and 2, and duplicate descriptions thereof are omitted here.

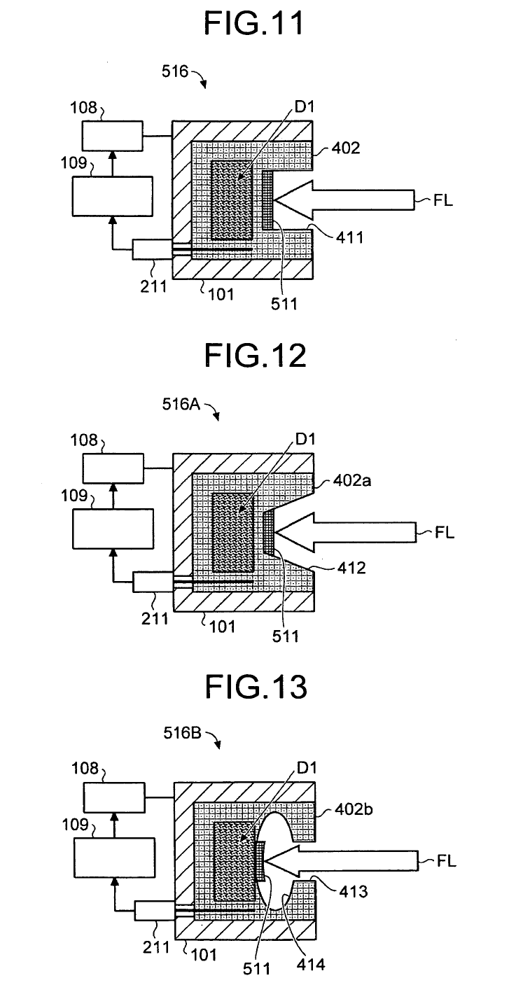

FIG. 11 is a sectional view schematically illustrating the configuration of the debris collection unit according to the fifth embodiment. FIG. 11 illustrates the configuration of the debris collection unit with a section taken along a plane containing the center of the magnetic flux of the magnetic field B. As illustrated in FIG. 11, the debris collection unit 516 may be similar in configuration to the debris collection unit 416 shown in FIG. 8, but a mesh member 511, serving as a sputtering prevention unit, may further be provided at the bottom of the cup-shaped pocket 411, i.e., on the surface on which the ion flow FL is incident. The mesh member 511 may, for example, be configured of a member having a similar configuration to the mesh member 303 shown in FIG. 6. The debris D1 incident on the mesh member 511 as the ion flow FL may permeate into the mesh member 511 through the openings in the surface, and may subsequently permeate into the porous member 402 provided so as to be in contact with the surface opposite the surface on which the debris D1 is incident. With this, the debris D1 may be trapped and stored in the porous member 402. Note that the mesh member 511 may preferably have lower wettability to the debris D1 than the porous member 402.

Other configurations and operations are similar to those of the above embodiments and the modifications thereof, and duplicate descriptions thereof are omitted here.

### First Modification

FIG. 12 is a sectional view schematically illustrating the configuration of a debris collection unit according to a first modification of the fifth embodiment. A debris collection unit 516A according to the first modification may be similar in configuration to the debris collection unit 416A shown in FIG. 9, and may further be provided with the mesh member 511, serving as a sputtering prevention unit, at the bottom of the frustoconical pocket 412, i.e., on the surface on which the ion flow FL is incident, as in the debris collection unit 516 shown in FIG. 11. The debris D1 incident on the mesh member 511 as the ion flow FL may permeate into the mesh member 511 through the openings in the surface, and may subsequently permeate into the porous member 402a provided so as to be in contact with the surface opposite the surface on which the debris D1 is incident. With this, the debris D1 may be trapped in the porous member 402a. Note that the mesh member 511 may preferably have lower wettability to the debris D1 than the porous member 402a.

### Second Modification

FIG. 13 is a sectional view schematically illustrating the configuration of a debris collection unit according to a second modification of the fifth embodiment. A debris collection unit 516B according to the second modification may be similar in configuration to the debris collection unit 416B shown in FIG. 10, and may further be provided with the mesh member 511, serving as a sputtering prevention unit, on the surface on which the ion flow FL is incident in the hollow space 414 of the porous member 402b, as in the debris collection unit 516 shown in FIG. 11 and the debris collection unit 516A shown in FIG. 12. The debris D1 incident on the mesh member 511 as the ion flow FL may permeate into the mesh member 511 through the openings in the surface, and may subsequently permeate into the porous member 402b provided so as to be in contact with the surface opposite the surface on which the debris D1 is incident. With this, the debris D1 may be trapped in the porous member 402b. Note that the mesh member 511 may preferably have lower wettability to the debris D1 than the porous member 402b.

### Sixth Embodiment

An EUV light generation apparatus and a debris collection unit according to a sixth embodiment of this disclosure will be described in detail with reference to the drawings. The EUV light generation apparatus according to the sixth embodiment may be similar in configuration to the EUV light generation apparatus 1 shown in FIGS. 1 and 2, but the debris collection unit 16 is replaced by a debris collection unit 616. Other configurations are similar to those shown in FIGS. 1 and 2, and duplicate descriptions thereof are omitted here.

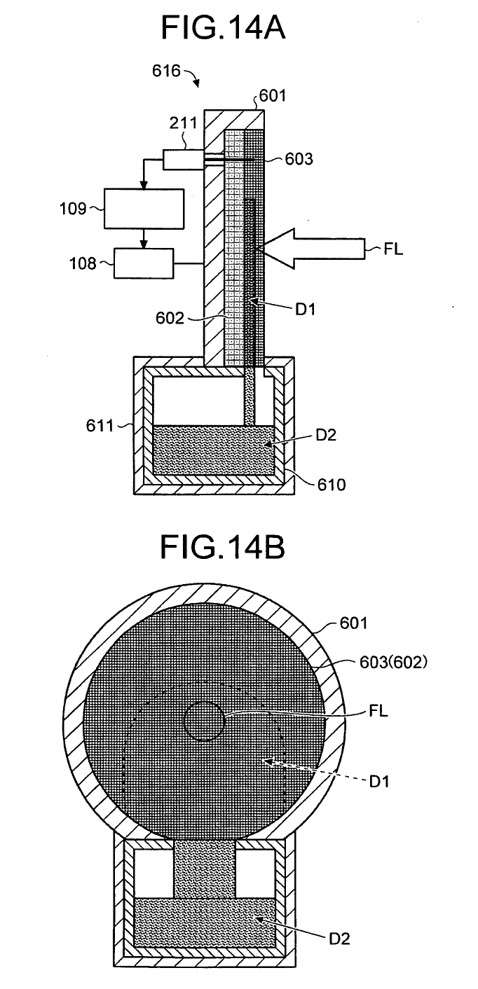

FIG. 14A is a sectional view schematically illustrating the configuration of the debris collection unit according to the sixth embodiment. FIG. 14A illustrates the configuration of the debris collection unit with a section taken along a plane containing the center of the magnetic flux of the magnetic field B. FIG. 14B schematically illustrates the configuration of the debris collection unit shown in FIG. 14A, as viewed in the direction in which the ion flow is incident on the debris collection unit. As illustrated in FIGS. 14A and 14B, the debris collection unit 616 may include a disc-shaped porous member 602 and a disc-shaped mesh member 603 provided on the surface of the porous member 602 on which the ion flow FL is incident. The porous member 602 may, for example, be configured of a member similar to the porous member 102 shown in FIG. 4. Meanwhile, the mesh member 603 may, for example, be configured of a member having a similar configuration to that of the mesh member 303 shown in FIG. 6. The debris D1 incident of the mesh member 603 as the ion flow FL may permeate into the mesh member 603 through the openings in the surface, and may subsequently permeate into the porous member 602 provided so as to be in contact with the surface opposite the surface on which the debris D1 is incident. With this, the debris D1 may be trapped in the porous member 602. Note that the mesh member 603 may preferably have lower wettability to the debris D1 than the porous member 602. A plate member may be used in place of the porous member 602. The plate member may preferably have low wettability to molten debris.

The debris collection unit 616 may be provided with a heater 601 for heating the porous member 602 and the mesh member 603 to a temperature at or above a temperature at which Sn, with which the debris is composed of, melts. The temperature controller 109 may control the electric current supplied from the power supply 108 to the heater 601 based on the temperature detected by the temperature sensor 211, whereby the temperatures of the porous member 602 and of the mesh member 603 may reliably be controlled to fall within a predetermined temperature range (for example, melting point of Sn (232° C.) or higher).

When the temperatures of the porous member 602 and of the mesh member 603 are regulated at or above the melting point of Sn, Sn (debris D1) trapped in the porous member 602 is maintained in a molten state; thus, it may flow in the vertical direction (downward direction in the drawing). A collection container 610 may be disposed below the porous member 602 and the mesh member 603, the collection container 610 having an opening at a connection where the collection container 610 is connected at least to either of the porous member 602 and the mesh member 603. Molten Sn flowing downward from the porous member 602 and the mesh member 603 may flow into the collection container 610. With this, the debris D1 trapped in the porous member 602 and the mesh member 603 may be stored, as debris D2, in the collection container 610.

A unit for storing the debris D2 being provided separately from a unit for trapping the debris D1, a larger amount of Sn can be stored, compared, for example, with a case where Sn (debris D1) is stored in the porous member or in the mesh member. Consequently, the number of times of performing maintenance work can be reduced. Furthermore, configuring the mesh member 603 with a member having lower wettability to the debris D1 than the porous member 602 may allow molten Sn to flow smoothly into the collection container 610. The collection container 610 may be provided with a heater 611 for maintaining the collection container 610 at a temperature at which Sn stored therein melts. Maintaining the collection container 610 at or above the melting point of Sn may allow Sn to be stored in the collection container 610 in a liquid state, whereby the volumetric efficiency can be increased.

Other configurations and operations are similar to those of the above embodiments and the modifications thereof, and duplicate descriptions thereof are omitted here.

### First Modification

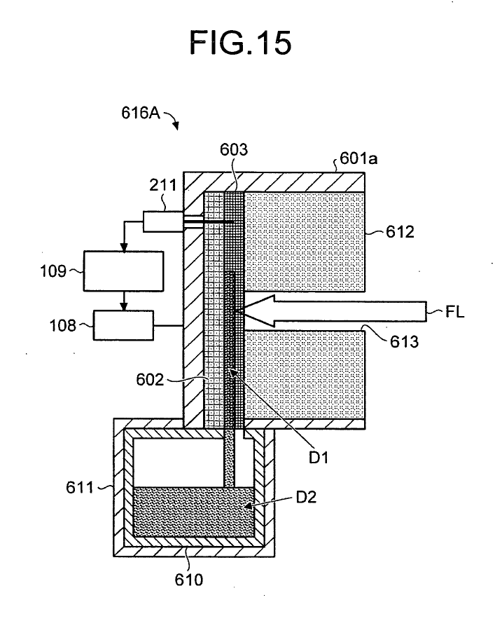

FIG. 15 is a sectional view schematically illustrating the configuration of a debris collection unit according to a first modification of the sixth embodiment. A debris collection unit 616A according to the first modification may be similar in configuration to the debris collection unit 616 shown in FIGS. 14A and 14B, and may further be provided with a columnar porous member 612 on the surface of the mesh member 603 on which the debris D1 is incident, the porous member 612, for example, having an opening 613 wider than the cross section of the ion flow FL. In this way, the columnar porous member 612 for receiving the ion flow FL being provided on the surface on which the ion flow FL is incident, sputtered materials generated as the ion flow FL is incident thereon may be trapped on the side surface of the opening in the porous member 612. Hence, the sputtered materials can be prevented from being scattered in the chamber 10. The heater 601 of the debris collection unit 616 shown in FIGS. 14A and 14B may be replaced by a heater 601a capable of heating the porous member 612, in addition to the porous member 602 and the mesh member 603.

### Second Modification

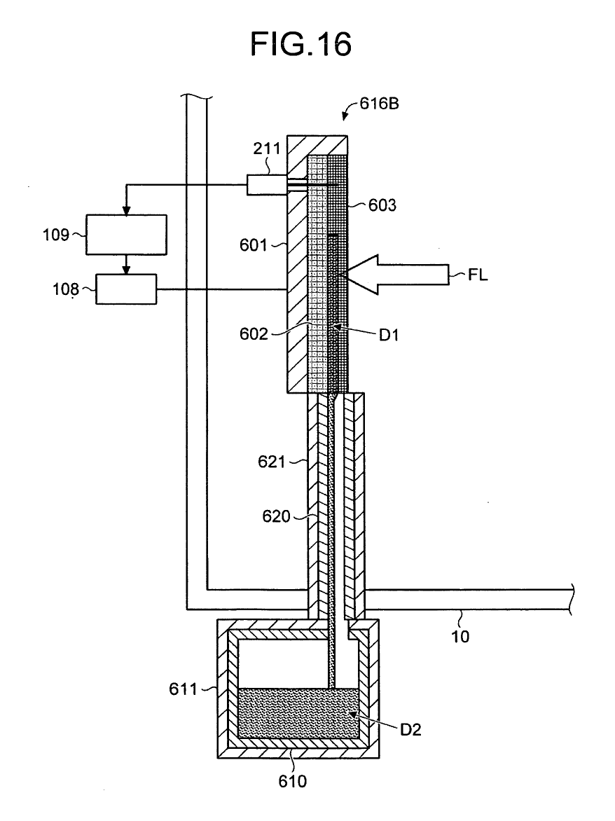

FIG. 16 is a sectional view schematically illustrating the configuration of a debris collection unit according to a second modification of the sixth embodiment. A debris collection unit 616B according to the second modification may be similar in configuration to the debris collection unit 616 shown in FIGS. 14A and 14B, but the collection container 610 may be disposed outside the chamber 10. A drain pipe 620 for guiding molten Sn flowing out of the porous member 602 and the mesh member 603 to the collection container 610 may be provided between the porous member 602 and the mesh member 603, and the collection container 610. The drain pipe 620 may be heated to a temperature at or above the melting point of Sn (232° C.), for example, with a heater 621. With such a configuration, the collection container 610 does not need to be provided inside the chamber 10 that has many limitations due to the space occupancy of other elements. Hence, the collection container 610 of relatively large capacity can be provided outside the chamber 10, and as a result, the number of times of performing maintenance work can be reduced.

### Third Modification

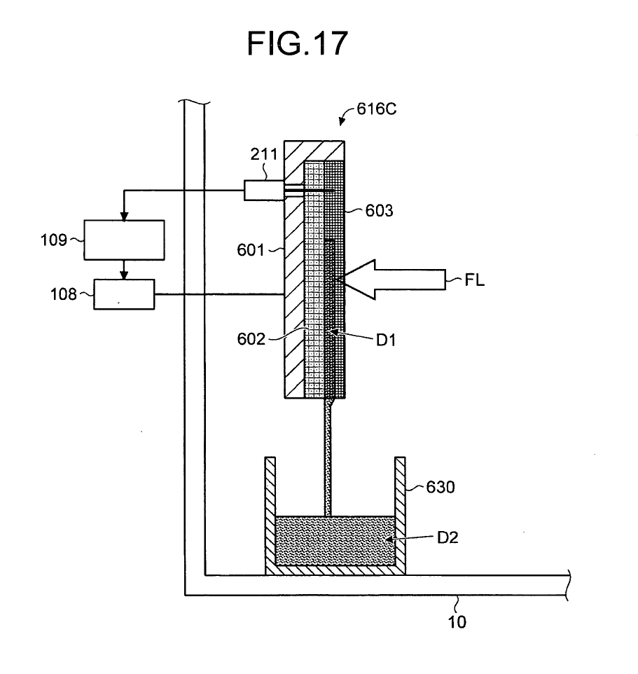

FIG. 17 is a sectional view schematically illustrating the configuration of a debris collection unit according to a third modification of the sixth embodiment. A debris collection unit 616C according to the third modification may be similar in configuration to the debris collection unit 616 shown in FIGS. 14A and 14B, but the collection container 610 may be replaced by a collection container 630 separated from the porous member 602 and the mesh member 603. The collection container 630 may be attached detachably to the inner wall of the chamber 10, below the porous member 602 and the mesh member 603. The debris D1 (molten Sn) trapped in the porous member 602 and the mesh member 603 may mainly flow out of the mesh member 603 and be collected, as the debris D2, into the collection container 630 provided therebelow. With such a configuration, since only the collection container 630 can be taken out of the chamber 10, the effort of performing maintenance work can be reduced.

### Seventh Embodiment

An EUV light generation apparatus and a debris collection unit according to a seventh embodiment of this disclosure will be described in detail with reference to the drawings. The EUV light generation apparatus according to the seventh embodiment may be similar in configuration to the EUV light generation apparatus 1 shown in FIGS. 1 and 2, but the debris collection unit 16 is replaced by a debris collection unit 716. Other configurations are similar to those shown in FIGS. 1 and 2, and duplicate descriptions thereof are omitted here.

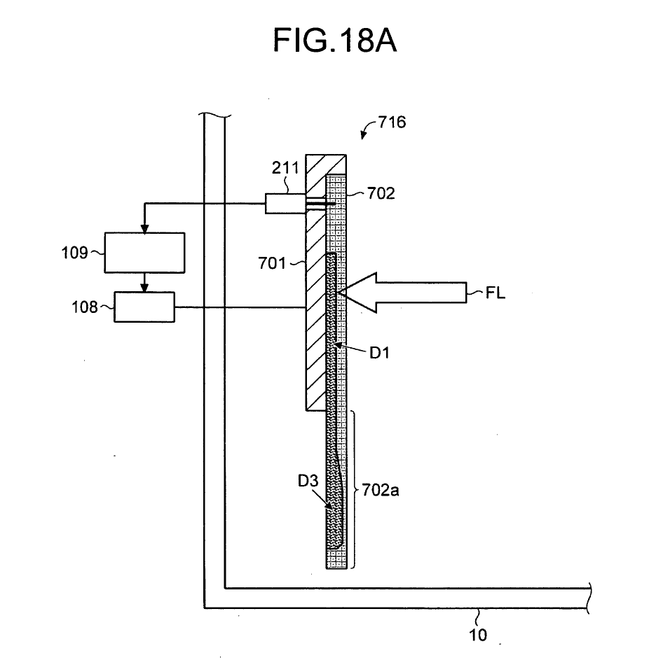

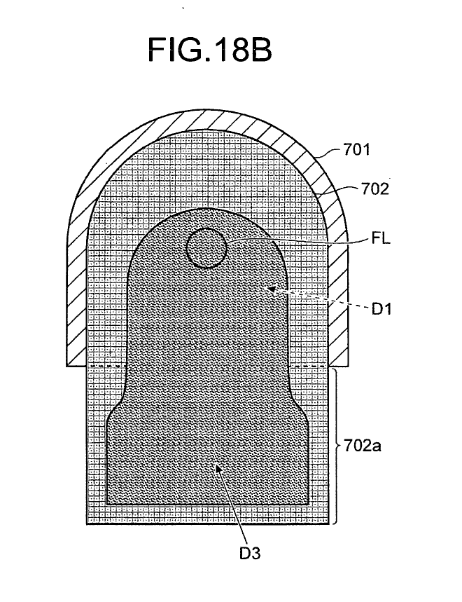

FIG. 18A is a sectional view schematically illustrating the configuration of the debris collection unit according to the seventh embodiment. FIG. 18A illustrates the configuration of the debris collection unit with a section taken along a plane containing the center of the magnetic flux of the magnetic field B. FIG. 18B schematically illustrates the configuration of the debris collection unit shown in FIG. 18A, as viewed in the direction in which the ion flow FL is incident thereon. As illustrated in FIGS. 18A and 18B, the debris collection unit 716 may include an oblong plate-shaped porous member 702. The porous member 702 may, for example, be configured of a member similar to that of the porous member 102 shown in FIG. 4.

One end of the porous member 702 in the longitudinal direction may be semicircular, and the porous member 702 may be disposed such that the semicircular portion thereof is positioned at the upper side in the vertical direction. Part of the porous member 702 including the semicircular portion may be provided with the temperature sensor 211 connected to the temperature controller 109 and a heater 701 connected to the power supply 108, and feedback-control may be performed such that the temperature of the porous member 702 falls within a predetermined temperature range (for example, at or above 232° C. and below 280° C.) based on the temperature detected by the temperature sensor 211. Hence, the debris D1 of Sn trapped in the porous member 702 may flow downwardly in the vertical direction while being maintained in a molten state.

The other end of the porous member 702 at the lower side in the vertical direction may project downwardly from the heater 701. The projecting portion may function as a storage portion 702a for storing Sn trapped in the upper part of the porous member 702. The storage portion 702a is not directly heated with the heater 701; thus, the temperature of the storage portion 702a may be below the melting point of Sn. Hence, molten Sn flowing down from the upper part of the porous member 702 may flow into the storage portion 702a, and may subsequently be cooled and solidified. With this, Sn may be stored, as debris D3, in the storage portion 702a.

Other configurations and operations are similar to those of the above embodiments and the modifications thereof, and duplicate descriptions thereof are omitted here.

### Eighth Embodiment

In the above embodiments, part of the debris collection unit on which the ion flow FL is incident has been configured of a member that allows liquid debris to permeate thereinto, such as a porous member or a mesh member. However, this disclosure is not limited thereto. For example, a member that does not allow debris to permeate thereinto may be provided at the part on which the ion flow FL is incident. Such a member may preferably be configured of a material having low wettability to molten debris. Hereinafter, this case will be described in detail, as an eighth embodiment, with reference to the drawings. The description to follow is based on the debris collection unit according to the second modification of the sixth embodiment described above. Furthermore, the eighth embodiment may be applied to any of the above embodiments and the modifications thereof.

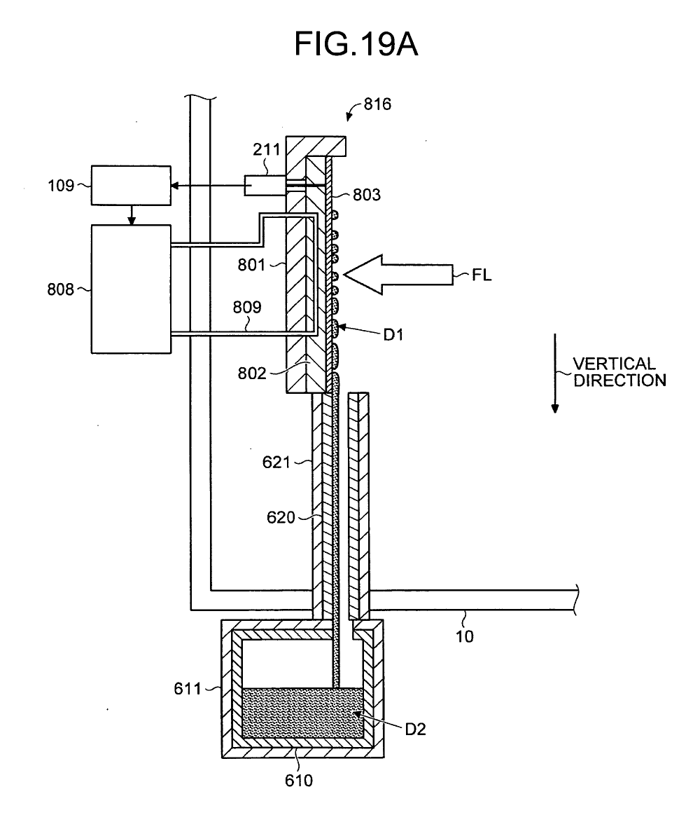

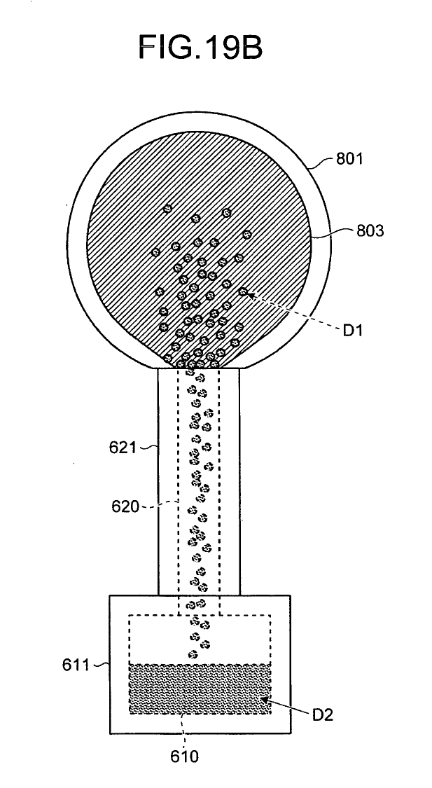

FIG. 19A illustrates the configuration of the debris collection unit with a section taken along a plane containing the center of the magnetic flux of the magnetic field B and the vertical direction. FIG. 19B schematically illustrates the configuration of the debris collection unit shown in FIG. 19A, as viewed in the direction in which the ion flow is incident thereon.

As illustrated in FIGS. 19A and 19B, a debris collection unit 816 according to the eighth embodiment may be similar in configuration to the debris collection unit 616B shown in FIG. 16, but the porous member 602 and the mesh member 603 (see FIG. 16) may be replaced by a plate member 802. The plate member 802 may be held, for example, by a holder 801. The plate member 802 may have a coating 803 formed on the surface thereof.

The plate member 802 may preferably be configured, for example, of a metal material such as copper or a ceramic material such as SiC, which has high thermal conductivity. The coating 803 may preferably be configured, for example, of a material that has low wettability to molten debris and has an excellent anti-sputtering characteristic. Further, the coating 803 may preferably be configured of a material which is less reactive with the debris (Sn in the eighth embodiment). Furthermore, in the case where reactive gas such as hydrogen is introduced into the chamber 10 for mitigating the debris, the coating 803 may preferably be configured of a material which is less reactive with the reactive gas. Examples of such a material may include SiC, carbon (C), or the like. If SiC is used as the material, the coating 803 can be formed by CVD (Chemical Vapor Deposition). In addition, the coating 803 may preferably have the surface thereof being formed without being polished or be rough to some extent.

The temperature of the debris collection unit 816 may rise upon the collision of the ion flow FL. The surface of the coating 803 is preferably at or above a temperature at which the debris, i.e., Sn melts. However, if the temperature of the surface of the coating 803 is higher than necessary, Sn adhered to the surface of the coating 803 may become susceptible to sputtering. Therefore, the temperature of the surface of the coating 803 is preferably regulated to fall within a predetermined range. Hence, in the eighth embodiment, the debris collection unit 816 may be provided with a cooler 808, as illustrated in FIGS. 19A and 19B. A pipe 809 through which a cooling medium such as cooled silicon oil, organic compound liquid, or the like flows may be connected to the cooler 808. Part of the pipe 809 may run inside or along the back of the plate member 802. The cooling medium cooled with the cooler 808 flows through the pipe 809, whereby the plate member 802 can be cooled so that the temperature of the surface of the coating 803 does not become excessively high. The cooler 808 and the pipe 809 may be applied to any of the above embodiments.

When the temperature detected by the temperature sensor 211 exceeds, for example, a first threshold temperature that is set in advance, the temperature controller 109 may drive the cooler 808, whereby the cooled cooling medium may be fed into the pipe 809. With this, the plate member 802 may be cooled. Consequently, the coating 803 formed on the surface of the plate member 802 may be cooled. The cooling medium may continuously be sent into the pipe 809 until, for example, the temperature detected by the temperature sensor 211 falls below a second threshold temperature that is set in advance. The second threshold temperature (below the first threshold temperature) may, for example, be the melting point of the target material (Sn). Note that the cooler 808 may be replaced by a constant-temperature circulator or the like capable of heating and cooling.

With such configurations and operations, in the eighth embodiment, the temperature of the surface of the coating 803 against which the ion flow FL collides may be maintained at or above the melting point of the debris (Sn). Further, the surface of the coating 803 has low wettability to the molten debris. Thus, the debris adhered to the surface of the coating 803 may flow in the vertical direction with its own weight while being maintained in a molten state. The drain pipe 620 may be provided at a position toward which the debris flows, as in the configuration shown in FIG. 16. The collection container 610 may be provided at the downstream end of the drain pipe 620. Hence, the debris flowing downwardly in the vertical direction may be collected into the collection container 610 via the drain pipe 620.

Other configurations and operations are similar to those of the above embodiments and the modifications thereof, and duplicate descriptions thereof are omitted here.

### Ninth Embodiment

Next, materials of the coating 803 exemplified in the eighth embodiment will be discussed in more detail below. The plate member 802 of the eighth embodiment may be configured of a material having lower wettability to molten Sn, as illustrated below. In such a case, the coating 803 may not need to be formed on the surface of the plate member 802. That is, it is sufficient to dispose a material having lower wettability to molten Sn on the surface on which the debris is incident, as illustrated below.

As has been described in the above eighth embodiment, the coating 803 may preferably be configured of a material that has low wettability to the molten debris, for example, and that has excellent anti-sputtering characteristics. Generally, materials having a contact angle θ of 0°<θ≦90° have an immersional wetting property. Thus, when the coating 803 is formed of a material having the contact angle θ of 0°<θ≦90° to the molten debris, the debris adhered to the surface of the coating 803 may be immersed and permeate into the coating 803. On the other hand, a material having the contact angle θ of θ>90° has an adhesive wetting property. Thus, when the coating 803 is configured of a material having the contact angle θ of θ>90° to the molten debris, the debris adhered to the surface of the coating 803 may be less likely to further wet the surface and may remain on the surface of the coating 803. Since the wetting is less likely to proceed, the debris adhered thereto may gradually move downwardly in the vertical direction due to its own weight.

Relationship between the materials and the contact angle to molten Sn, i.e., the debris, illustrated in the above embodiments will be shown in Table 2 below.

TABLE 2

| Material | Contact Angle (°) |
|---|---|
| Mo | 30-70 |
| SiC | 123-150 |
| SiN | 140-168 |
| Al₂O₃ | 163 |
| ZrO₂ | 140-153 |
| Graphite | 149 |
| Diamond | 125-135 |
| SiOx | 120-150 |
| MoOx | 120-130 |
| (Without Preheating in | |
| Vacuum) | |

As is clear from the Table 2, silicon carbide (SiC), silicon nitride (SiN), aluminum oxide (Al₂O₃), zirconium oxide (ZrO₃), graphite, diamond, silicon oxide (SiOx), and molybdenum oxide (MoOx) have the contact angle θ>90° to molten Sn and has lower wettability to molten Sn. Thus, these may be preferred materials of the coating 803 and the plate member 802.

Aside from the material listed in Table 2 above, molybdenum (Mo), tungsten (W), and tantalum (Ta), being oxidatively treated, may have lower wettability to molten Sn. Thus, these may also be preferred materials for the coating 803 and the plate member 802.

Next, reactivity of molten Sn with various materials will be discussed below. Generally, tungsten (W), tantalum (Ta), molybdenum (Mo), and so on, which are high melting point materials, has a stable property to Sn. That is, these materials are less reactive with Sn.

Silicon carbide (SiC), silicon nitride (SiN), aluminum oxide (Al₂O₃), zirconium oxide (ZrO₃), graphite, diamond, silicon oxide (SiOx), and molybdenum oxide (MoOx) also have a stable property to molten Sn. That is, these materials are also less reactive with molten Sn.

Further, tungsten oxide (WO₃) and tantalum oxide (Ta₂O₅) also have a stable property to molten Sn. That is, these materials are also less reactive with molten Sn.

Based on the above, silicon carbide (SiC), silicon nitride (SiN), aluminum oxide (Al₂O₃), zirconium oxide (ZrO₃), graphite, diamond, silicon oxide (SiOx), molybdenum oxide (MoOx), tungsten oxide (WO₃), or tantalum oxide (Ta₂O₅) may be a preferred material for the coating 803 and the plate member 802. Alternatively, a material containing one or more of these materials may serve as the materials for the coating 803 and the plate member 802.

Further, from the viewpoint of low sputtering rate to the debris, carbon (C) may be considered as a material for the coating 803 and the plate member 802.

The materials having lower wettability to molten Sn, as has been exemplified above, may be applied to the part on which the debris is incident in the debris collection unit (16, 216, 216A, 316, 316A, 416, 416A, 416B, 516, 516A, 516B, 616, 616A, 616B, 616C, 716, 816) illustrated in the above first through seventh embodiments and the modifications thereof. The part on which the debris is incident refers, for example, to the porous member 102, the mesh member 202, the porous member 402, the porous member 402a, the porous member 402b, the porous member 602, and the porous member 702, configuring the debris collection unit, or the mesh member 303, the porous member 304, the mesh member 511, the mesh member 603, and the porous member 612, serving as the sputtering prevention unit for preventing the materials mentioned above from being sputtered.

The above-described embodiments and the modifications thereof are merely examples for implementing this disclosure, and this disclosure is not limited thereto. Making various modifications according to the specifications or the like is within the scope of this disclosure, and it is apparent from the above description that other various embodiments are possible within the scope of this disclosure. For example, it is needless to state that the modifications illustrated for each of the embodiments can be applied to other embodiments as well.

What is claimed is:

1. A chamber apparatus used with a laser apparatus and a focusing optical system for focusing a laser beam outputted from the laser apparatus, the chamber apparatus comprising:
a chamber provided with an inlet through which the laser beam is introduced into the chamber;
a target supply unit provided to the chamber for supplying a target material to a predetermined region inside the chamber; and
a collection unit provided in the chamber for collecting a charged particle generated when the target material is irradiated with the laser beam in the chamber.

2. The chamber apparatus according to claim 1, wherein the collection unit includes a porous material.

3. The chamber apparatus according to claim 2, further comprising a temperature regulation unit for maintaining at least part of the collection unit to fall within a predetermined temperature range.

4. The chamber apparatus according to claim 3, wherein
the temperature regulation unit includes
a heating unit for heating the collection unit,
a power supply for supplying power to the heating unit,
a temperature sensor for detecting a temperature of the collection unit, and
a temperature control unit for controlling the power supply based on the temperature detected by the temperature sensor so as to maintain a temperature of at least part of the collection unit to fall within the predetermined temperature range.

5. The chamber apparatus according to claim 4, wherein the predetermined temperature range ranges from a temperature at a melting point of the target material to a temperature at and above which the target material reacts with the porous material.

6. The chamber apparatus according to claim 3, further comprising a collection container provided below the collection unit in the vertical direction for storing the target material collected in the collection unit.

7. The chamber apparatus according to claim 3, further comprising:
a collection container provided below the collection unit in the vertical direction with a space provided therebetween for storing the target material collected in the collection unit;
a drain pipe provided between the collection unit and the collection container for guiding the target material flowing out of the collection unit to the collection container; and
a drain pipe heating unit for maintaining the drain pipe at or above a melting point of the target material.

8. The chamber apparatus according to claim 2, further comprising a sputtering prevention unit provided on a side of the collection unit on which the charged particle is incident.

9. The chamber apparatus according to claim 8, wherein the sputtering prevention unit is configured of a material having lower wettability to the target material in a molten state than the collection unit.

10. The chamber apparatus according to claim 8, wherein
the collection unit includes a recess formed in the side thereof on which the charged particle is incident,
the sputtering prevention unit is provided at the bottom of the recess, and
the sputtering prevention unit is configured of a material having lower wettability to the target material in a molten state than the collection unit.

11. The chamber apparatus according to claim 2, wherein the collection unit includes a scattering prevention unit for preventing a sputtered material generated by the charged particle being incident on the collection unit from being scattered in the chamber.

12. The chamber apparatus according to claim 1, wherein a surface of the collection unit on which the charged particle is incident is configured of a material containing at least any one of silicon carbide, silicon nitride, aluminum oxide, zirconium oxide, graphite, diamond, silicon oxide, molybdenum oxide, tungsten oxide, tantalum oxide, and carbon.

13. The chamber apparatus according to claim 1, further comprising a temperature regulation unit for maintaining at least part of the collection unit to fall within a predetermined temperature range.

14. The chamber apparatus according to claim 13, wherein the temperature regulation unit includes a cooler for cooling the collection unit and a temperature sensor for detecting a temperature of the collection unit.

15. The chamber apparatus according to claim 14, wherein the temperature regulation unit controls the cooler based on a temperature detected by the temperature sensor.

16. The chamber apparatus according to claim 13, wherein a surface of the collection unit on which the charged particle is incident is formed of a material containing at least any one of silicon carbide, silicon nitride, aluminum oxide, zirconium oxide, graphite, diamond, silicon oxide, molybdenum oxide, tungsten oxide, tantalum oxide, and carbon.
